(19) United States
(12) Patent Application Publication
(10) Pub. No.: US 2025/0087806 A1
(43) Pub. Date: Mar. 13, 2025

(54) BATTERY-ELECTRIC SYSTEM FOR A UTILITY VEHICLE

(71) Applicant: DEERE & COMPANY, MOLINE, IL (US)

(72) Inventor: STEFAN BROCKE, MANNHEIM (DE)

(21) Appl. No.: 18/795,339

(22) Filed: Aug. 6, 2024

(30) Foreign Application Priority Data
Sep. 8, 2023 (DE) 102023124199.0

(51) Int. Cl. H01M 50/233; B60K 1/04; H01M 50/244; H01M 50/249; H01M 50/262

(52) U.S. Cl. CPC H01M 50/233; B60K 1/04; H01M 50/244; H01M 50/249; H01M 50/262; B60K 2001/045; H01M 2220/20

(57) ABSTRACT

A battery-electric system for a utility vehicle. The battery-electric system includes a wheel rim and at least one toroidal battery arrangement that is accommodated in a free region of the wheel rim. The at least one toroidal battery arrangement has, in a fastening region that is designed for attachment to a vehicle axle, an interface for releasably establishing a rotation-independent electrical and/or fluidic communication connection to a vehicle-based operating system.

### CROSS-REFERENCE TO RELATED APPLICATIONS

This application claims priority to German Patent Application No. 102023124199.0, filed on Sep. 8, 2023, which is hereby incorporated by reference herein.

### TECHNICAL FIELD

The present disclosure relates generally to a battery-electric system for a utility vehicle, in particular an agricultural tractor.

### BACKGROUND

Battery-electric systems for the operation of vehicles are presently gaining in importance, specifically in the automotive sector, with regard to reducing the CO₂ emissions that arise from the combustion of fossil fuels. In relation to the automotive sector, however, the power requirement of utility vehicles may be greater.

### SUMMARY

This applies in particular to agricultural tractors, because these are required to perform work with an increased tractive force requirement for several hours without interruption. One example of such work is the ploughing of heavy agricultural soils. In general, the structural space required for the use of a battery-electric system with an appropriate energy capacity is not available in the region of an engine compartment or of a load-bearing chassis of the agricultural tractor owing to functional constraints such as the presence of required operating or working units or relatively large-volume tires.

It is therefore an object of the present disclosure to specify a battery-electric system which is adapted for use in a utility vehicle, in particular an agricultural tractor.

This object is achieved by a battery-electric system for a utility vehicle, in particular an agricultural tractor, having the features of one or more embodiments disclosed herein.

The battery-electric system for a utility vehicle, in particular an agricultural tractor, comprises a wheel rim and at least one toroidal or ring-shaped battery arrangement that is accommodated in an empty or free region of the wheel rim, wherein the at least one toroidal battery arrangement has, in a fastening region that is designed for attachment to a vehicle axle, an interface for releasably establishing a rotation-independent electrical and/or fluidic communication connection to a vehicle-based operating system.

The battery-electric system according to the disclosure makes use of the fact that the wheels of utility vehicles have a relatively large diameter. This applies particularly to the tires and thus the wheel rims of agricultural tractors. For example, the specification of John Deere 7R Series tractors states a maximum tire size of 170 cm (front) and 215 cm (rear).

Particularly space-saving integration of the battery-electric system in the utility vehicle is possible by accommodating the toroidal battery arrangement within the otherwise unused empty or free region of the wheel rim. Here, the battery-electric system may serve to expand the capacity of a main battery system of the utility vehicle, or else may be the sole main battery system if the utility vehicle has a hybrid drive.

The electrical and/or fluidic communication connection to the operating system that is established via the interface is for example an electrical power transmission connection, a liquid connection to a coolant circuit, and/or an electrical connection for data communication purposes. Accordingly, the vehicle-based operating system has not only a liquid-cooling device provided for the operation of the coolant circuit but also has an energy supply and/or charge management system which, aside from coordinating a current-drawing or charging operation, serves in particular for monitoring the temperature and state of charge of the battery-electric system.

In particular, the interface has a first interface connector in the region of a central rim disk of the wheel rim, wherein, on the vehicle axle, more specifically on a wheel hub that is provided for the attachment of the wheel rim, there is a complementary second interface connector which, in turn, is connected to a rotary feedthrough provided on the vehicle axle. Here, when the rim disk is mounted onto the wheel hub, the two interface connectors are connected to one another electrically or in liquid-tight fashion, such that a rotation-independent electrical or fluidic communication connection to the vehicle-based operating system is ultimately established via the rotary feedthrough.

Advantageous developments of the battery-electric system according to the disclosure can be found in the one or more embodiments disclosed herein.

The at least one toroidal battery arrangement may include a concatenation of a multiplicity of battery modules designed as ring segments. Each battery module may include a module body within which a multiplicity of battery cells is accommodated. The battery cells are typically of cylindrical, prismatic or pouch type. Owing to their power density, cylindrical battery cells may be preferred, wherein said battery cells are arranged or interconnected in matrix-like form within the module body, and wherein non-conductive cooling liquid that is fed by the vehicle-based operating system via the fluidic communication connection to the module body, or to a liquid-conducting system provided therein, may flow around said battery cells during operation. The individual battery modules are additionally encapsulated in liquid-tight fashion within a module housing. The module housing may include plastics material processed by injection molding.

It is possible here that that the battery modules, at their end sides facing one another radially, have complementarily designed module interfaces for fitting together and for establishing an electrical and/or fluidic communication connection between them. Any defective battery modules can be easily exchanged by detaching the module interfaces. Said module interfaces may be designed as plug-in and latching connectors and secured by mechanical installation means. Each of the module interfaces comprises an arrangement of plug contacts for transmitting electrical power and/or data and of liquid-tight coupling elements for transferring the cooling liquid that circulates in the coolant circuit.

With regard to further increasing the charge capacity of the battery-electric system, provision may be made whereby, along the wheel-rim axis, that is to say along its axial extent, at least two toroidal battery arrangements are arranged adjacent to one another in the form of a battery stack, wherein said battery arrangements have complementarily designed battery interfaces for establishing an electrical and/or fluidic communication connection between them. Similarly to the module interfaces, the battery interfaces may be designed as plug-in and latching connectors and secured by additional mechanical installation means. Each of the battery interfaces in turn comprises an arrangement of plug contacts for transmitting electrical power and/or data and of liquid-tight coupling elements for transferring the cooling liquid that circulates in the coolant circuit.

The module and battery interfaces not only allow an incorporation into the coolant circuit or the establishment of an electrical connection to the energy supply and/or charge management system of the battery-electric system, but in particular also allow data to be exchanged among the battery modules or the toroidal battery arrangements.

There are various conceivable options with regard to the accommodation of the at least one toroidal battery arrangement.

It is firstly possible for the at least one toroidal battery arrangement to extend along an outer circumference of the wheel rim, in particular of a rim well which is bordered by associated rim flanges and which serves for the installation of a vehicle tire. The empty or free region that is used for accommodating the at least one toroidal battery arrangement is in this case a tire air volume that is enclosed by the rim well and by a vehicle tire installed thereon.

On the other hand, the toroidal battery arrangement may also extend along an inner circumference of the wheel rim and thus utilize the empty or free region within the wheel rim, which region is radially bordered by a rim ring. In this case, the at least one toroidal battery arrangement is installed either on the rim ring and/or on the central rim disk which is connected to or formed integrally with said rim ring and which serves for the attachment of the wheel rim to the vehicle axle or to the wheel hub comprised by said vehicle axle.

Provision may be made here for the at least one toroidal battery arrangement to be arranged along an inner circumference of the wheel rim so as to be accessible for the purposes of uninstallation or exchange at a later point in time.

It is furthermore conceivable for a system housing of the at least one toroidal battery arrangement to at the same time be an integral constituent part of a load-bearing rim structure. Like the rest of the rim body, the system housing may include sheet steel that has been shaped in a deep-drawing process. If the at least one toroidal battery arrangement is arranged along an outer circumference of the wheel rim, the system housing, which encircles the rim well, can at the same time serve as a supporting ring in the event of a tire pressure loss caused by a defect (so-called run-flat system).

In order to allow the at least one toroidal battery arrangement to be uninstalled or exchanged at a later point in time in this case, too, the system housing may be installed removably on the rim body.

The battery-electric system according to the disclosure for a utility vehicle will be discussed in more detail below with reference to the appended drawings. Components of equivalent or comparable function are identified by the same reference signs.

Other features and aspects will become apparent by consideration of the detailed description, claims, and accompanying drawings.

### BRIEF DESCRIPTION OF THE DRAWINGS

The detailed description of the drawings refers to the accompanying figures. In the drawings:

FIG. 1 shows a perspective sectional view of a battery-electric system according to the disclosure, which is provided on a vehicle axle of an agricultural tractor, and which has toroidal battery arrangements extending along an inner circumference of a wheel rim.

FIG. 2 shows one of the toroidal battery arrangements depicted in FIG. 1 in an uninstalled state.

FIG. 3 shows a battery module including the toroidal battery arrangement in FIG. 2, and which has a multiplicity of cylindrical battery cells.

FIG. 4 shows a first variant of the battery-electric system illustrated in FIG. 1, in which the toroidal battery arrangements are additionally surrounded by a protective system housing.

FIG. 5 shows a second variant of the battery-electric system illustrated in FIG. 1, having toroidal battery arrangements extending along an outer circumference of the wheel rim, with said battery arrangements likewise being situated within a protective system housing.

Like reference numerals are used to indicate like elements throughout the several figures.

### DETAILED DESCRIPTION

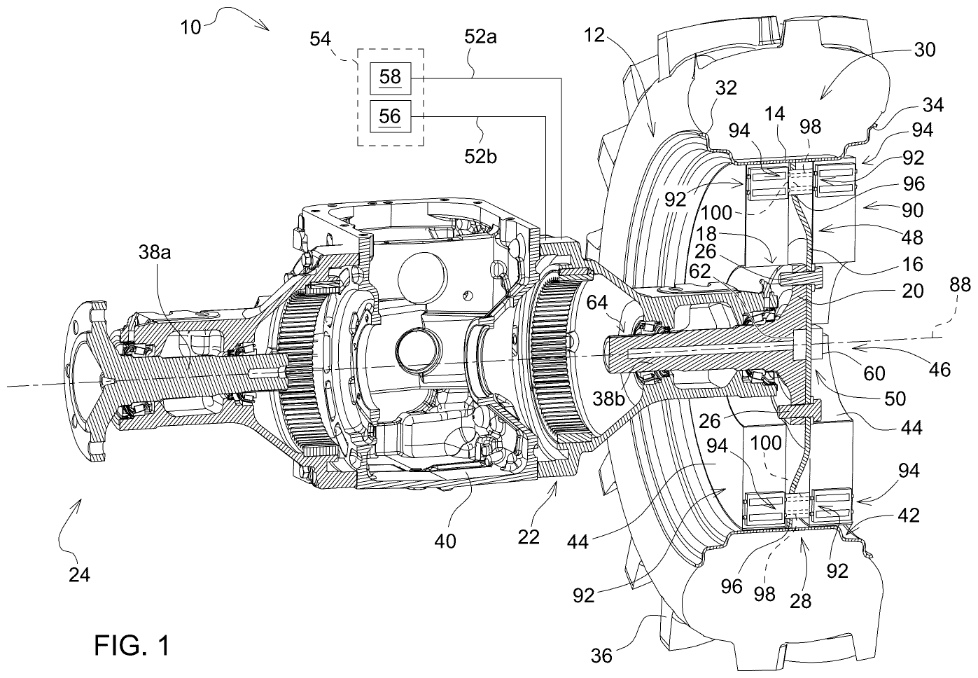

FIG. 1 shows, in a perspective sectional view, an exemplary embodiment of the battery-electric system according to the disclosure for a utility vehicle in the form of an agricultural tractor.

The battery-electric system 10 comprises a wheel rim 12 having a rim ring 14 and a central rim disk 16 which is connected to or formed integrally with said rim ring and which is attached, in a fastening region 18, to a wheel hub 20 of a vehicle axle 22 of the agricultural tractor 24 (not illustrated in any more detail) by means of multiple threaded bolts 26. A rim well 30 which is provided along an outer circumference 28 of the rim ring 14 is bounded by oppositely situated and mutually parallel rim flanges 32, 34 and serves for the installation of an associated vehicle tire 36.

In the example, the vehicle axle 22 is one of the two driven rear axles 38a, 38b of the agricultural tractor 24, wherein the rear axles 38a, 38b extend outward to both sides of a differential housing 40. For the sake of clarity, the battery-electric system 10 is illustrated only for the right-hand rear axle 38a but is in fact provided equivalently on the left-hand rear axle 38b.

As can also be seen in FIG. 1, a toroidal battery arrangement 44 is accommodated on each of the two sides of the rim disk 16, in each case along an inner circumference 42 of the wheel rim 12, in an empty or free region 46 that is radially bordered by the rim ring 14. The two toroidal battery arrangements 44 are in this case installed on the rim disk 16; installation on the rim ring 14 is additionally or alternatively possible. In other words, the rim disk 16 or rim ring 14 forms an installation support 48 for the two toroidal battery arrangements 44, with said battery arrangements being releasably attached to the installation support 48 using suitable fastening elements (not shown). Here, the toroidal battery arrangements 44 are arranged along the inner circumference 42 of the wheel rim 12 so as to be accessible from the outside for the purposes of being uninstalled from or exchanged on the wheel rim 12 at a later point in time and can be removed from the installation support 48 after the fastening elements have been released and removed.

Particularly space-saving integration of the battery-electric system 10 in the agricultural tractor 24 is possible by accommodating the toroidal battery arrangements 44 within the otherwise unused empty or free region 46 of the wheel rim 12. Here, the battery-electric system 10 is used to expand the capacity of a main battery system of the agricultural tractor 24. Said battery-electric system is alternatively the sole main battery system if the agricultural tractor 24 has a hybrid drive.

Furthermore, in the fastening region 18, which is designed for attachment to a vehicle axle 22, of the wheel rim 12, an interface 50 is provided for releasably establishing a rotation-independent electrical and/or fluidic communication connection 52a, 52b between the toroidal battery arrangements 44 and a vehicle-based operating system 54.

In the example, the electrical and/or fluidic communication connection 52a, 52b to the vehicle-based operating system 54 that is established via the interface 50 is an electrical power transmission connection, a liquid connection to a coolant circuit, and/or an electrical connection for data communication purposes. Accordingly, the vehicle-based operating system 54 has not only a liquid-cooling device 56 provided for the operation of the coolant circuit but also has an energy supply and/or charge management system 58 which, aside from coordinating a current-drawing or charging operation, serves in particular for monitoring the temperature and state of charge of the battery-electric system 10.

More specifically, the interface 50 has a first interface connector 60 in the region of the rim disk 16 of the wheel rim 12, wherein, on the vehicle axle 22, more specifically on the wheel hub 20 that is provided for the attachment of the wheel rim 12, there is a complementary second interface connector 62 which, in turn, is connected to a rotary feedthrough 64 provided on the vehicle axle 22. Here, when the rim disk 16 is mounted onto the wheel hub 20, the two interface connectors 60, 62 are connected to one another electrically or in liquid-tight fashion, such that a rotation-independent electrical or fluidic communication connection 52a, 52b to the vehicle-based operating system 54 is ultimately established via the rotary feedthrough 64.

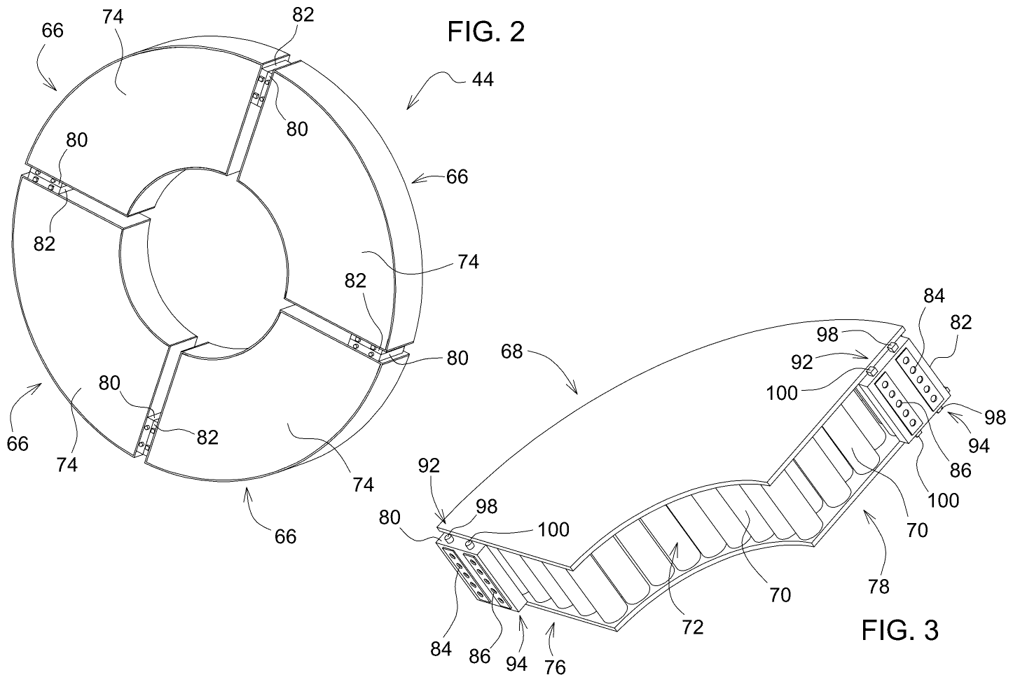

FIG. 2 illustrates one of the two toroidal battery arrangements 44 in an uninstalled state. As can be seen, each of the toroidal battery arrangements 44 may include a concatenation of a multiplicity of battery modules 66 designed as ring segments. As can be seen from the opened state shown in FIG. 3, each battery module 66 may include a module body 68 (see FIG. 3), within which a multiplicity of cylindrical battery cells 70 is accommodated. The cylindrical battery cells 70 are arranged or interconnected in matrix-like form within the module body 68, and non-conductive cooling liquid that is fed by the vehicle-based operating system 54 via the fluidic communication connection 52b to the module body 68, or to a liquid-conducting system 72 provided therein and comprising an arrangement of internal guide walls, channels and the like (not visible in the illustration in FIG. 3), flows around said battery cells during operation. The individual battery modules 66 are additionally encapsulated in liquid-tight fashion within a module housing 74 (see FIG. 2). The module housings 74 may include plastics material processed by injection molding.

In the present case, each of the toroidal battery units 44 has four battery modules 66 designed as quadrants, but it is also possible for any other number to be provided depending on the diameter of the toroidal battery units 44.

As can also be seen in FIGS. 2 and 3, the battery modules 66, at their end sides 76, 78 facing one another radially, have complementarily designed module interfaces 80, 82 for fitting together and for establishing an electrical and/or fluidic communication connection between them. Any individual defective battery modules 66 can be easily exchanged by detaching the module interfaces 80, 82. The module interfaces 80, 82 are designed as plug-in and latching connectors that are additionally secured by mechanical installation means (not shown). Each of the module interfaces 80, 82 comprises an arrangement of plug contacts 84 for transmitting electrical power and/or data and of liquid-tight coupling elements 86 for transferring the cooling liquid that circulates in the coolant circuit.

In the example, to increase the charge capacity of the battery-electric system 10, two toroidal battery units 44 are provided for each of the two rear wheels of the agricultural tractor 24. The two toroidal battery units 44 are arranged adjacent to one another along the wheel rim axis 88, that is to say along its axial extent, in the form of a battery stack 90 (see FIG. 1). Said battery units have complementarily designed battery interfaces 92, 94 for fitting together and for establishing an electrical and/or fluidic communication connection between them. Similarly to the module interfaces 80, 82, the battery interfaces 92, 94 extending through recesses 96 formed in the rim disk 16 are designed as plug-in and latching connectors. The fastening to the rim disk 16 or rim ring 14 eliminates the need for any additional mechanical securing means, because said fastening holds the toroidal battery units 44 fixedly in position relative to one another. However, each of the battery interfaces 92, 94 in turn comprises an arrangement of plug contacts 98 for transmitting electrical power and/or data and of liquid-tight coupling elements 100 for transferring the cooling liquid that circulates in the coolant circuit.

The module and battery interfaces 80, 82, 92, 94 (see FIG. 3), which for the purposes of simplified line routing are integrated into respective common assemblies, not only allow an incorporation into the coolant circuit of the liquid-cooling device 56 or the establishment of an electrical connection to the energy supply and/or charge management system 58 of the battery-electric system 10, but in particular also allow data to be exchanged among the battery modules 66 or the toroidal battery arrangements 44.

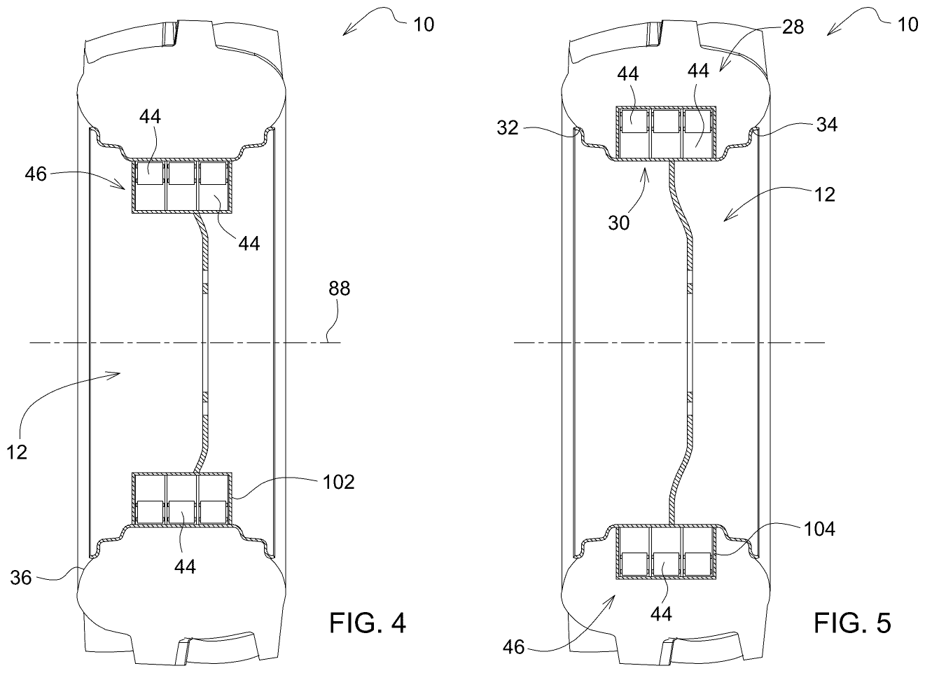

FIG. 4 shows a first variant of the battery-electric system 10 illustrated in FIG. 1, in which the two toroidal battery arrangements 44 are supplemented by another, wherein said battery arrangements are additionally surrounded by a protective system housing 102, which is at the same time an integral constituent part of a load-bearing rim structure. For the sake of stability, the multi-part system housing 102, like the rest of the rim body, may include sheet steel that has been shaped in a deep-drawing process.

FIG. 5 furthermore illustrates a second variant of the battery-electric system 10 illustrated in FIG. 1. Here, the toroidal battery arrangements 44 extend along the outer circumference 28 of the wheel rim 12, more specifically of the rim well 30 that is bordered by the rim flanges 32, 34. The empty or free region 46 that is used for accommodating the toroidal battery arrangements 44 is in this case a tire air volume that is enclosed by the rim well 30 and by the vehicle tire 36 installed thereon. A system housing 104 encircles the rim well 30 and at the same time also serves as a supporting ring in the event of a tire pressure loss caused by a defect (so-called run-flat system).

In order to allow the toroidal battery units 44 to be uninstalled or exchanged, the system housing 102, 104 in each of the two variants is installed removably on the rim body.

Unless otherwise limited or modified, lists with elements that are separated by conjunctive terms (e.g., “and” or “or”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

The teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A battery-electric system for a utility vehicle, the battery-electric system comprising:
a wheel rim and at least one toroidal battery arrangement that is accommodated in a free region of the wheel rim, wherein the at least one toroidal battery arrangement has, in a fastening region that is designed for attachment to a vehicle axle, an interface for releasably establishing one or more of a rotation-independent electrical or fluidic communication connection to a vehicle-based operating system.

2. The battery-electric system of claim 1, wherein the at least one toroidal battery arrangement includes a concatenation of a multiplicity of battery modules designed as ring segments.

3. The battery-electric system of claim 2, wherein the battery modules, at their end sides facing one another radially, have complementarily designed module interfaces for fitting together and for establishing an electrical or fluidic communication connection between them.

4. The battery-electric system of claim 1, wherein, along a wheel-rim axis, at least two toroidal battery arrangements are arranged adjacent to one another in the form of a battery stack, wherein the battery arrangements have complementarily designed battery interfaces for establishing an electrical or fluidic communication connection between them.

5. The battery-electric system of claim 1, wherein the at least one toroidal battery arrangement extends along an outer circumference of the wheel rim which serves for the installation of a vehicle tire.

6. The battery-electric system of claim 1, wherein the at least one toroidal battery arrangement extends along an inner circumference of the wheel rim.

7. The battery-electric system of claim 1, wherein the at least one toroidal battery arrangement is arranged along an inner circumference of the wheel rim so as to be accessible from the outside.

8. The battery-electric system of claim 1, wherein a system housing of the at least one toroidal battery arrangement is at the same time an integral constituent part of a load-bearing rim structure.

9. The battery-electric system of claim 8, wherein the system housing is installed removably on the rim body.

10. A utility vehicle, comprising:
a wheel rim and at least one toroidal battery arrangement that is accommodated in a free region of the wheel rim, wherein the at least one toroidal battery arrangement has, in a fastening region that is designed for attachment to a vehicle axle, an interface for releasably establishing one or more of a rotation-independent electrical or fluidic communication connection to a vehicle-based operating system.

11. The utility vehicle of claim 10, wherein the at least one toroidal battery arrangement includes a concatenation of a multiplicity of battery modules designed as ring segments.

12. The utility vehicle of claim 11, wherein the battery modules, at their end sides facing one another radially, have complementarily designed module interfaces for fitting together and for establishing an electrical or fluidic communication connection between them.

13. The utility vehicle of claim 10, wherein, along a wheel-rim axis, at least two toroidal battery arrangements are arranged adjacent to one another in the form of a battery stack, wherein the battery arrangements have complementarily designed battery interfaces for establishing an electrical or fluidic communication connection between them.

14. The battery-electric system of claim 10, wherein the at least one toroidal battery arrangement extends along an outer circumference of the wheel rim which serves for the installation of a vehicle tire.

15. The utility vehicle of claim 10, wherein the at least one toroidal battery arrangement extends along an inner circumference of the wheel rim.

16. The utility vehicle of claim 10, wherein the at least one toroidal battery arrangement is arranged along an inner circumference of the wheel rim so as to be accessible from the outside.

17. The utility vehicle of claim 10, wherein a system housing of the at least one toroidal battery arrangement is at the same time an integral constituent part of a load-bearing rim structure.

18. The utility vehicle of claim 17, wherein the system housing is installed removably on the rim body.
